(19) United States
(12) Patent Application Publication
(10) Pub. No.: US 2025/0061203 A1
(43) Pub. Date: Feb. 20, 2025

(54) DEVICE RUNTIME UPDATE PRE-AUTHENTICATION

(71) Applicant: Intel Corporation, Santa Clara, CA (US)

(72) Inventors: Shamanna DATTA, Hillsboro, OR (US); Mahesh NATU, Folsom, CA (US); Jiewen YAO, Shanghai (CN); Xiaoyu RUAN, Folsom, CA (US); Andrew Martyn DRAPER, Chesham, Buckinghamshire (GB); Raghunandan MAKARAM, Northborough, MA (US); Alberto MUNOZ, Los Altos, CA (US)

(73) Assignee: Intel Corporation, Santa Clara, CA (US)

(21) Appl. No.: 18/724,426

(22) PCT Filed: Feb. 25, 2022
(86) PCT No.: PCT/CN2022/077854

§ 371 Date: Jun. 26, 2024

(51) Int. Cl. G06F 21/57; G06F 21/53; G06F 21/54

(52) U.S. Cl. CPC G06F 21/572; G06F 21/53; G06F 21/54

(57) ABSTRACT

A method comprises establishing, in a trusted security manager of a trusted execution environment, a device update pre-authentication policy for a device communicatively coupled to the trusted execution manager, providing the device update pre-authentication policy to the device, receiving, from the device, a pre-authentication event signal, and providing, to the device, a pre-authentication event response comprising an update indicator to indicate to the device whether a runtime update may be performed.

### CLAIM OF PRIORITY

This application claims, under 35 U.S.C. § 371, the benefit of and priority to International Application No. PCT/CN2022/077854, filed Feb. 25, 2023, titled DEVICE RUNTIME UPDATE PRE-AUTHENTICATION, the entire content of which is incorporated herein by reference.

### BACKGROUND

In a cloud computing system, such as a data center platform, information is stored, transmitted, and used by many different information processing systems and/or devices. In some instances, the information processing systems and/or devices may require updates to software and/or firmware. Such updates have traditionally required the systems and/or devices to be reset to complete an update, which removes the information processing systems and/or devices from a runtime environment. Recently, however, data center operators have developed interest in performing runtime updates that do not require such information processing systems and/or devices to be reset. For example, cloud service providers (CSPs) may need to update a component to the latest version to implement a security fix while keeping the platform alive without performing a reset.

Accordingly, systems and techniques to facilitate runtime updates may find utility, e.g., in enhancing security for cloud computing systems.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a schematic illustration of a processing environment in which systems and methods in which device runtime update pre-authentication may be implemented, according to embodiments.

FIG. 2 is a simplified block diagram of an example system including an example platform which supports device runtime update pre-authentication in accordance with an embodiment.

FIG. 3 is a simplified block diagram representing a computing environment in accordance with one embodiment.

FIG. 4 is a simplified, high-level flow diagram of a method for device runtime update pre-authentication according to an embodiment.

FIG. 5 is a diagram illustrating operational flows in a method for device runtime update pre-authentication according to an embodiment.

FIG. 6 is a block diagram illustrating a computing architecture which may be adapted to provide a method for device runtime update pre-authentication according to an embodiment.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Example Cloud Computing Environment with Trusted Execution

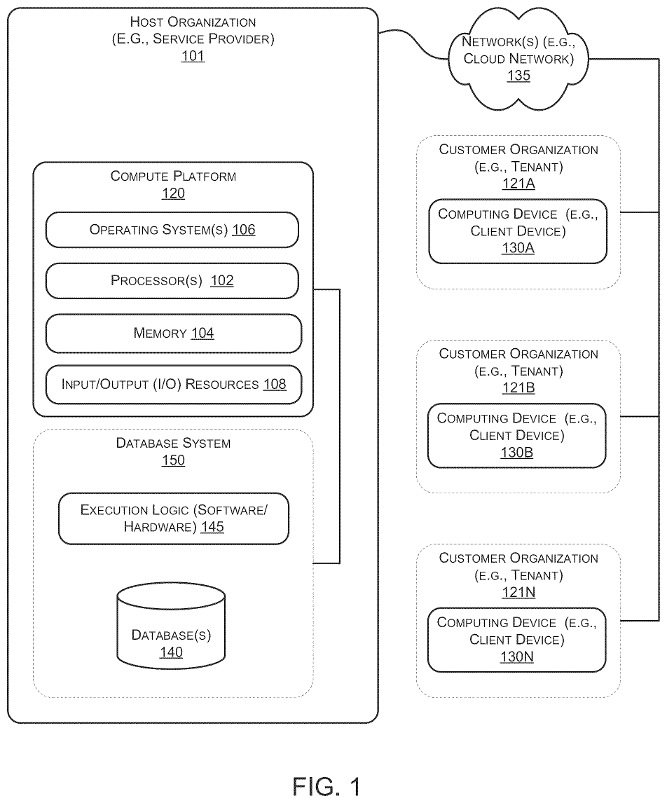

FIG. 1 is a schematic illustration of a processing environment in which systems and methods for device runtime update pre-authentication may be implemented, according to embodiments. Referring to FIG. 1, a system 100 may comprise a compute platform 120. In one embodiment, compute platform 120 includes one or more host computer servers for providing cloud computing services. Compute platform 120 may include (without limitation) server computers (e.g., cloud server computers, etc.), desktop computers, cluster-based computers, set-top boxes (e.g., Internet-based cable television set-top boxes, etc.), etc. Compute platform 120 includes an operating system (“OS”) 106 serving as an interface between one or more hardware/physical resources of compute platform 120 and one or more client devices 130A-130N, etc. Compute platform 120 further includes processor(s) 102, memory 104, input/output (“I/O”) sources 108, such as touchscreens, touch panels, touch pads, virtual or regular keyboards, virtual or regular mice, etc.

In one embodiment, host organization 101 may further employ a production environment that is communicably interfaced with client devices 130A-N through host organization 101. Client devices 130A-N may include (without limitation) customer organization-based server computers, desktop computers, laptop computers, mobile compute platforms, such as smartphones, tablet computers, personal digital assistants, e-readers, media Internet devices, smart televisions, television platforms, wearable devices (e.g., glasses, watches, bracelets, smartcards, jewelry, clothing items, etc.), media players, global positioning system-based navigation systems, cable setup boxes, etc.

In one embodiment, the illustrated database system 150 includes database(s) 140 to store (without limitation) information, relational tables, datasets, and underlying database records having tenant and user data therein on behalf of customer organizations 121A-N (e.g., tenants of database system 150 or their affiliated users). In alternative embodiments, a client-server computing architecture may be utilized in place of database system 150, or alternatively, a computing grid, or a pool of work servers, or some combination of hosted computing architectures may be utilized to carry out the computational workload and processing that is expected of host organization 101.

The illustrated database system 150 is shown to include one or more of underlying hardware, software, and/or logic elements 145 that implement, for example, database functionality and a code execution environment within host organization 101. In accordance with one embodiment, database system 150 further implements databases 140 to service database queries and other data interactions with the databases 140. In one embodiment, hardware, software, and logic elements 145 of database system 150 and its other elements, such as a distributed file store, a query interface, etc., may be separate and distinct from customer organizations (121A-121N) which utilize the services provided by host organization 101 by communicably interfacing with host organization 101 via network(s) 135 (e.g., cloud network, the Internet, etc.). In such a way, host organization 101 may implement on-demand services, on-demand database services, cloud computing services, etc., to subscribing customer organizations 121A-121N.

In some embodiments, host organization 101 receives input and other requests from a plurality of customer organizations 121A-N over one or more networks 135; for example, incoming search queries, database queries, application programming interface (“API”) requests, interactions with displayed graphical user interfaces and displays at client devices 130A-N, or other inputs may be received from customer organizations 121A-N to be processed against database system 150 as queries via a query interface and stored at a distributed file store, pursuant to which results are then returned to an originator or requestor, such as a user of client devices 130A-N at any of customer organizations 121A-N.

As aforementioned, in one embodiment, each customer organization 121A-N may include an entity selected from a group consisting of a separate and distinct remote organization, an organizational group within host organization 101, a business partner of host organization 101, a customer organization 121A-N that subscribes to cloud computing services provided by host organization 101, etc.

In one embodiment, requests are received at, or submitted to, a server within host organization 101. Host organization 101 may receive a variety of requests for processing by host organization 101 and its database system 150. For example, incoming requests received at the server may specify which services from host organization 101 are to be provided, such as query requests, search request, status requests, database transactions, graphical user interface requests and interactions, processing requests to retrieve, update, or store data on behalf of one of customer organizations 121A-N, code execution requests, and so forth. Further, the server at host organization 101 may be responsible for receiving requests from various customer organizations 121A-N via network(s) 135 on behalf of the query interface and for providing a web-based interface or other graphical displays to one or more end-user client devices 130A-N or machines originating such data requests.

Further, host organization 101 may implement a request interface via the server or as a stand-alone interface to receive requests packets or other requests from the client devices 130A-N. The request interface may further support the return of response packets or other replies and responses in an outgoing direction from host organization 101 to one or more client devices 130A-N.

It is to be noted that terms like “node”, “computing node”, “server”, “server device”, “cloud computer”, “cloud server”, “cloud server computer”, “machine”, “host machine”, “device”, “compute platform”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request”, and “message” may be used interchangeably throughout this document.

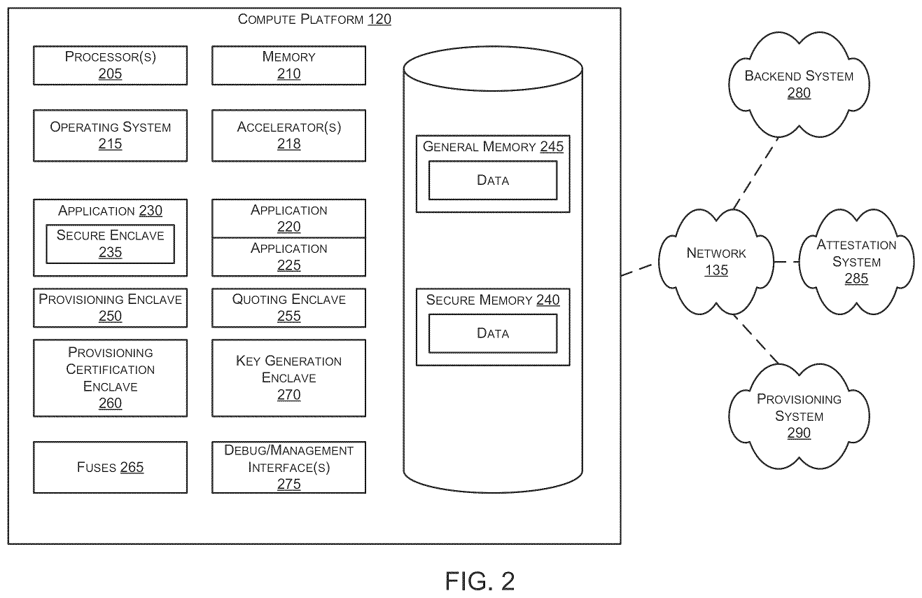

FIG. 2 is a simplified block diagram of an example system including an example compute platform 120 which may be adapted to support device runtime update pre-authentication accordance with an embodiment. Referring to the example of FIG. 2, a compute platform 120 can include one or more processor devices 205, one or more memory elements 210, and other components implemented in hardware and/or software, including an operating system 215 and a set of applications (e.g., 220, 225, 230), and one or more accelerators 218 (e.g., a graphics processor, image processor, matrix processor, or the like). One or more of the applications may be implemented in a trusted execution environment secured using, for example, a secure enclave 235, or application enclave. Secure enclaves can be implemented using secure memory 240 (as opposed to general memory 245) and utilizing secured processing functionality of at least one of the processors (e.g., 205) of the compute platform 120 to implement private regions of code and data to provide secured or protected execution of the application.

Logic, implemented in firmware and/or software of the compute platform (such as code of the CPU of the host), can be provided on the compute platform 120 that can be utilized by applications or other code local to the compute platform to set aside private regions of code and data, which are subject to guarantees of heightened security, to implement one or more secure enclaves on the system. For instance, a secure enclave can be used to protect sensitive data from unauthorized access or modification by rogue software running at higher privilege levels and preserve the confidentiality and integrity of sensitive code and data without disrupting the ability of legitimate system software to schedule and manage the use of platform resources. Secure enclaves can enable applications to define secure regions of code and data that maintain confidentiality even when an attacker has physical control of the platform and can conduct direct attacks on memory. Secure enclaves can further allow consumers of the host devices (e.g., compute platform 120) to retain control of their platforms including the freedom to install and uninstall applications and services as they choose. Secure enclaves can also enable compute platform 120 to take measurements of an application's trusted code and produce a signed attestation, which may be rooted in the processor, that includes this measurement and other certification that the code has been correctly initialized in a trusted execution environment (and is capable of providing the security features of a secure enclave, such as outlined in the examples above).

In some examples, attestation can be provided on the basis of a signed piece of data, or “quote,” that is signed using an attestation key securely provisioned on the platform. Additional secured enclaves can be provided (i.e., separate from the secure application enclave 235) to measure or assess the application and its enclave 235, sign the measurement (included in the quote), and assist in the provisioning of one or more of the enclaves with keys for use in signing the quote and established secured communication channels between enclaves or between an enclave and an outside service (e.g., backend system 280, attestation system 285,). For instance, one or more provisioning enclaves 250 can be provided to interface with a corresponding provisioning system to obtain attestation keys for use by a quoting enclave 255 and/or application enclave. One or more quoting enclaves 255 can be provided to reliably measure or assess an application 230 and/or the corresponding application enclave 235 and sign the measurement with the attestation key obtained through the corresponding provisioning enclave 250.

In some examples, a provisioning certification enclave 260 may also be provided to authenticate a provisioning enclave (e.g., 250) to its corresponding provisioning system (e.g., 120). The provisioning certification enclave 260 can maintain a provisioning attestation key that is based on a persistently maintained, secure secret on the host platform 120, such as a secret set in fuses 265 of the platform during manufacturing, to support attestation of the trustworthiness of the provisioning enclave 250 to the provisioning system 290, such that the provisioning enclave 250 is authenticated prior to the provisioning system 290 entrusting the provisioning enclave 250 with an attestation key. In some implementations, the provisioning certification enclave 260 can attest to authenticity and security of any one of potentially multiple provisioning enclaves 250 provided on the platform 120. For instance, multiple different provisioning enclaves 250 can be provided, each interfacing with its own respective provisioning system, providing its own respective attestation keys to one of potentially multiple quoting enclaves (e.g., 255) provided on the platform. For instance, different application enclaves can utilize different quoting enclaves during attestation of the corresponding application, and each quoting enclave can utilize a different attestation key to support the attestation, e.g., via an attestation system 285. Further, through the use of multiple provisioning enclaves 250 and provisioning services provided, e.g., by one or more provisioning systems 290, different key types and encryption technologies can be used in connection with the attestation of different applications and services (e.g., hosted by backend systems 280).

In some implementations, rather than obtaining an attestation key from a remote service (e.g., provisioning system 290), one or more applications and quoting enclaves can utilize keys generated by a key generation enclave 270 provided on the platform. To attest to the reliability of the key provided by the key generation enclave, the provisioning certification enclave 260 can sign the key (e.g., the public key of a key pair generated randomly by the key generation enclave) such that quotes signed by the key can be identified as legitimately signed quotes. In some cases, key generation enclaves (e.g., 270) and provisioning enclaves (e.g., 250) can be provided on the same platform, while in other instances, key generation enclaves (e.g., 270) and provisioning enclaves (e.g., 250) can be provided as alternatives for the other (e.g., with only a key generation enclave or provisioning enclaves be provided on a given platform), among other examples and implementations.

### Device Runtime Update Pre-Authentication

As described above, data center operators have developed interest in performing runtime updates that do not require such information processing systems and/or devices to be reset. For example, cloud service providers (CSPs) may need to update a component to the latest version to implement a security fix while keeping the platform alive without performing a reset. In response, efforts are being made to develop techniques to pull a device into the Trusted Computing Base (TCB) of a confidential computing environment.

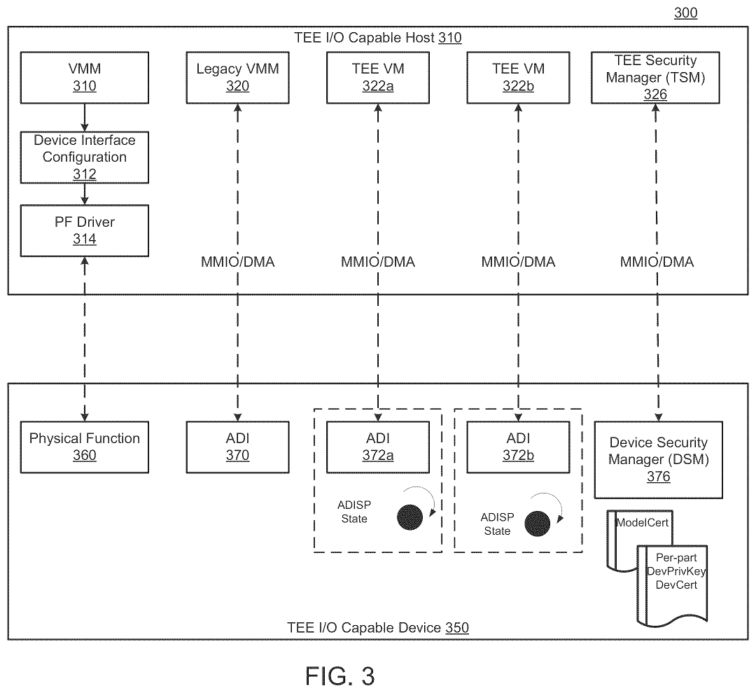

FIG. 3 is a simplified block diagram representing a computing environment in accordance with one embodiment. Referring to FIG. 3, in some examples a computing environment 300 comprises a trusted Execution Environment (TEE) capable host 310 which includes a host TEE virtual machine (TVM) 310 communicatively coupled to a device interface configuration 312 and a physical function (PF) driver 314. Host 310 further comprises a legacy virtual machine manager (VMM) 320, and one or more TEE virtual machines 322a, 322b, etc. Host 310 further comprises a TEE security manager (TSM) 326.

Computing environment 300 further comprises a TEE input/output (I/O) capable device 350. In some examples, the device 350 implements a physical function 360 which may be managed by the PF driver 314. Device 350 may further comprise an application data interface (ADI) 370 communicatively coupled to legacy VMM 320 and one or more application data interfaces 372a, 372b communicatively coupled to the respective TMM VMs 322a, 322b. Device 350 may further comprise a device security manager (DSM) 376 communicatively coupled to the TEE security manager 326.

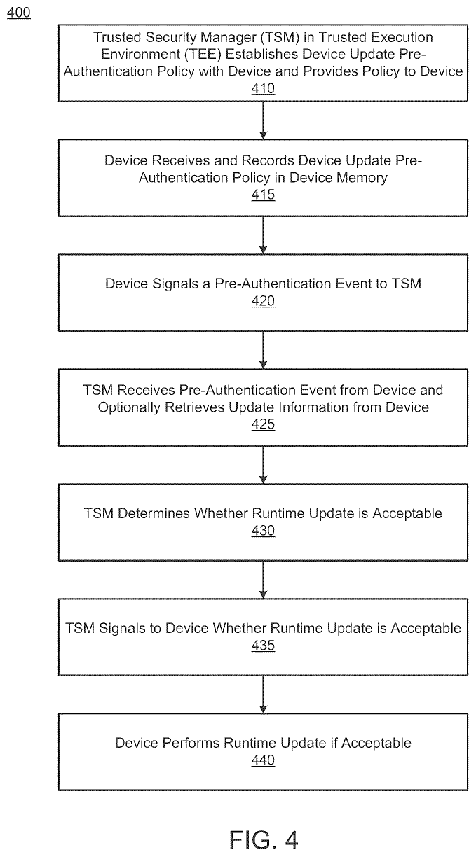

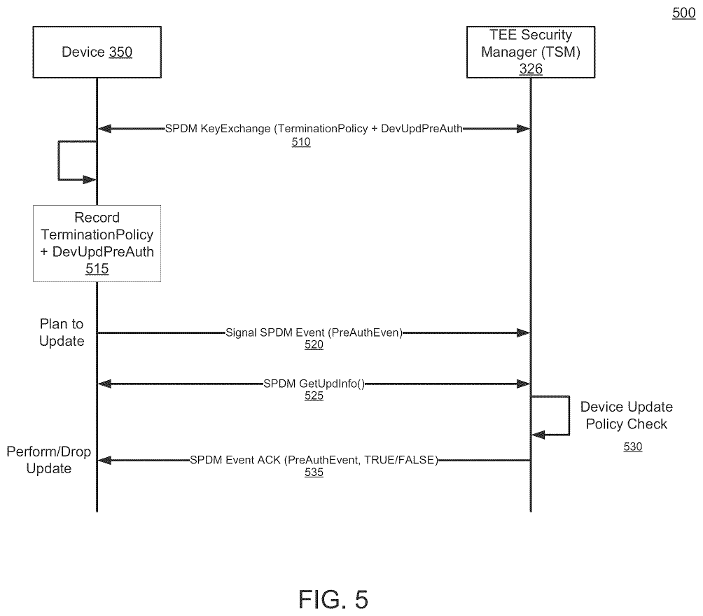

In some examples it may be useful to establish a trust relationship between various components of the host 310 (e.g., the TEE security manager 326 and the TEE VMs (322a, 322b) and the device 350. Examples of techniques to implement runtime update pre-authentication are described with reference to FIG. 4, which is a simplified, high-level flow diagram of a method for device runtime update pre-authentication according to an embodiment, and FIG. 5, which is a diagram illustrating operational flows in a method for device runtime update pre-authentication according to an embodiment.

Referring to FIG. 4, at operation 410 the trusted security manager 326 establishes a device update pre-authentication policy for the device 350 and provides the policy to the device 350. In some examples the device update pre-authentication policy may be implemented as a binary parameter which may be assigned a first value to indicate that pre-authentication is required for the device following an update or a second value to indicate that pre-authentication is not required for the device following an update. In further examples the pre-authentication policy may comprise additional parameters such as, for example, a timestamp, a notification policy in the event of a failure, or the like. In some examples the Security Version Number (SVN) of the device update being pre-authenticated can be included in this pre-authentication policy, since an update with same or an incremental SVN usually a requirement for most host systems to make sure they do not allow their secrets provisioned into device 351 to be compromised by device 351 getting updated into a lower SVN that may have security vulnerabilities. Another useful parameter that can be part of pre-authentication policy is signing policy of the update (i.e., a debug/release level). Debug level signed updates of device 351 usually are not acceptable to host as they may have debug hooks that may expose device provisioned secrets.

At operation 415, the device 350 receives and records the device update pre-authentication policy in a computer-readable memory. Subsequently, when the device 350 sets up a runtime update, the device 350 checks the device update pre-authentication policy value. If the device update pre-authentication policy is set to a value that indicates that pre-authentication is not required, then it can perform an update directly. By contrast, if the device update pre-authentication policy is set to a value that indicates pre-authentication is required, then at operation 420 the device 350 signals a pre-authentication event to the trusted security manager 326 One example of a case in which pre-authentication is not needed is that of a host workload having provisioned none of its secrets into device 350. In additional, the pre-authentication event may from other network component (such as backend system 280, attestation system 285, or provisioning system 290) to the trusted security manager 326 via an out of band channel, instead of from the device 350 via device-host communication channel.

At operation 425 the trusted security manager 326 receives the signal for a pre-authentication event from the device 350. In some examples the signal for the pre-authentication event may comprise additional basic firmware update information such as a secure version number (SVN) associated with the firmware, a debug mode firmware image, and the like. Optionally, the trusted security manager 326 may request additional information from the device 350 for use in a pre-authentication operation. For example, the trusted security manager 326 may request a new device firmware measurement and/or a new device firmware certificate.

At operation 430 the trusted security manager 326 determines whether a runtime update is acceptable for the device 350. In some examples the trusted security manager 326 may maintain a pre-defined update policy for the device. The policy may involve collecting update policies from multiple trusted virtual machine (TVM) components. For example, if a TVM has a policy of not allowing any device update then trusted security manager may determine that updating device 350 at this instant of time is not acceptable. An embodiment may allow deferred acceptance of device update or may decide to wait until a trusted virtual machine hosted by TSM will run into completion or terminates for any reason.

At operation 435, the trusted security manager 326 signals to the device 350 whether a runtime update is acceptable. In some examples the signal may comprise a binary parameter which may be assigned a first value to indicate that a runtime update is acceptable for the device 350 or a second value to indicate that a runtime update is not acceptable for the device 350. In further examples the signal may comprise additional parameters such as, for example, deferred acceptance of a runtime update. At operation 440 the device 350 performs a runtime update if the signal indicates it is acceptable.

In some examples the host 310 and the device 350 may communicate pursuant to the Distributed Management Task Force (DMTF) Security Protocol and Data Model (SPDM) protocol. FIG. 5 illustrates operational flows in a method for device runtime update pre-authentication in a SPDM environment. Referring to FIG. 5, during the session setup phase between the host trusted security manager 326 and the device TSM may use a SPDM KeyExchange command to setup a DeviceUpdatePreAuth policy using a binary value (e.g., TRUE/FALSE) with the device 350. At operation 515 the device 350 records this policy.

Subsequently, when the device 350 prepares to perform a runtime update, the device 350 checks the DeviceUpdatePreAuth policy received from the trusted security manager 326. If the Device UpdatePreAuth policy is FALSE, then no pre-auth action is required and the device 350 can perform update directly. By contrast, if the DeviceUpdatePreAuth policy is TRUE, then at operation 520 the device 350 signals an SPDM event (PreAuthEvent) to the trusted security manager 326 within the SPDM session. The PreAuthEvent can carry some basic firmware update information such as secure version number (SVN), debug mode FW or not etc. Alternatively, a network component which plans to perform the device update may communicate with the trusted security manager and send the PreAuth event in an out of band channel.

After the trusted security manager 326 receives the event, at operation 525, the trusted security manager 326 may use an SPDM command GetUpdateInfo( ) to retrieve more detailed information from the device 350. The detailed information may include new device firmware measurement, and new device firmware certificate, SVN, debug/release signed status etc.

In some examples, at operation 530 the trusted security manager 326 can check a pre-defined policy to determine if this runtime update is acceptable or not. The trusted security manager 326 policy check may involve multiple Trusted Virtual Machine (TVM) components and can be performed in local machine or remote machine.

At operation 535 the trusted security manager 326 returns an SPDM event ACK (PreAuthEvent) or a SPDM command (PreAuthCommand) with a decision (Allow=TRUE, Deny=FALSE) to the device 350. The event or command may also include the new device firmware identity information, such as new device firmware version, digest of the new device firmware package, digest of the new device firmware measurements and/or the new device certificates, etc. After receiving the SPDM event ACK or SPDM command, the device 350 may decide whether to perform the update or to drop the update based upon the PreAuthEvent ACK result. If the event or command include the new device firmware identity information, the device 350 shall also check if the new device firmware identity in the event or command matches its new device firmware image.

### Exemplary Computing Architecture

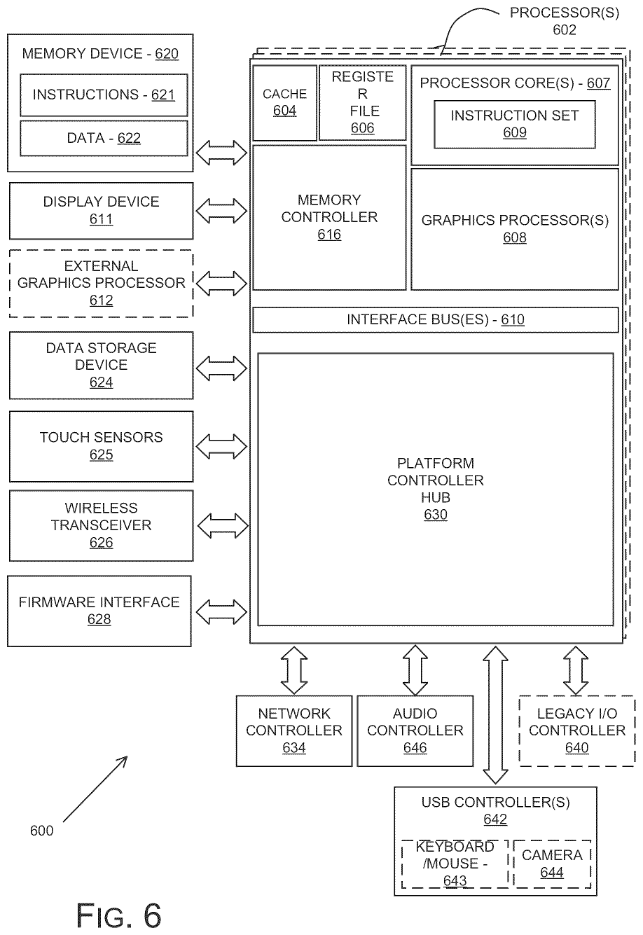

FIG. 6 is a block diagram illustrating a computing architecture which may be adapted to implement a secure address translation service using a permission table) and based on a context of a requesting device in accordance with some examples. The embodiments may include a computing architecture supporting one or more of (i) verification of access permissions for a translated request prior to allowing a memory operation to proceed; (ii) prefetching of page permission entries of an HPT responsive to a translation request; and (iii) facilitating dynamic building of the HPT page permissions by system software as described above.

In various embodiments, the computing architecture 600 may comprise or be implemented as part of an electronic device. In some embodiments, the computing architecture 600 may be representative, for example, of a computer system that implements one or more components of the operating environments described above. In some embodiments, computing architecture 600 may be representative of one or more portions or components in support of a secure address translation service that implements one or more techniques described herein.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 includes one or more processors 602 and one or more graphics processors 608, and may be a single processor desktop system, a multiprocessor workstation system, or a server system having a large number of processors 602 or processor cores 607. In on embodiment, the system 600 is a processing platform incorporated within a system-on-a-chip (SoC or SOC) integrated circuit for use in mobile, handheld, or embedded devices.

An embodiment of system 600 can include, or be incorporated within, a server-based gaming platform, a game console, including a game and media console, a mobile gaming console, a handheld game console, or an online game console. In some embodiments system 600 is a mobile phone, smart phone, tablet computing device or mobile Internet device. Data processing system 600 can also include, couple with, or be integrated within a wearable device, such as a smart watch wearable device, smart eyewear device, augmented reality device, or virtual reality device. In some embodiments, data processing system 600 is a television or set top box device having one or more processors 602 and a graphical interface generated by one or more graphics processors 608.

In some embodiments, the one or more processors 602 each include one or more processor cores 607 to process instructions which, when executed, perform operations for system and user software. In some embodiments, each of the one or more processor cores 607 is configured to process a specific instruction set 614. In some embodiments, instruction set 609 may facilitate Complex Instruction Set Computing (CISC), Reduced Instruction Set Computing (RISC), or computing via a Very Long Instruction Word (VLIW). Multiple processor cores 607 may each process a different instruction set 609, which may include instructions to facilitate the emulation of other instruction sets. Processor core 607 may also include other processing devices, such a Digital Signal Processor (DSP).

In some embodiments, the processor 602 includes cache memory 604. Depending on the architecture, the processor 602 can have a single internal cache or multiple levels of internal cache. In some embodiments, the cache memory is shared among various components of the processor 602. In some embodiments, the processor 602 also uses an external cache (e.g., a Level-3 (L3) cache or Last Level Cache (LLC)) (not shown), which may be shared among processor cores 607 using known cache coherency techniques. A register file 606 is additionally included in processor 602 which may include different types of registers for storing different types of data (e.g., integer registers, floating point registers, status registers, and an instruction pointer register). Some registers may be general-purpose registers, while other registers may be specific to the design of the processor 602.

In some embodiments, one or more processor(s) 602 are coupled with one or more interface bus(es) 610 to transmit communication signals such as address, data, or control signals between processor 602 and other components in the system. The interface bus 610, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 602 include an integrated memory controller 616 and a platform controller hub 630. The memory controller 616 facilitates communication between a memory device and other components of the system 600, while the platform controller hub (PCH) 630 provides connections to I/O devices via a local I/O bus.

Memory device 620 can be a dynamic random-access memory (DRAM) device, a static random-access memory (SRAM) device, flash memory device, phase-change memory device, or some other memory device having suitable performance to serve as process memory. In one embodiment the memory device 620 can operate as system memory for the system 600, to store data 622 and instructions 621 for use when the one or more processors 602 execute an application or process. Memory controller hub 616 also couples with an optional external graphics processor 612, which may communicate with the one or more graphics processors 608 in processors 602 to perform graphics and media operations. In some embodiments a display device 611 can connect to the processor(s) 602. The display device 611 can be one or more of an internal display device, as in a mobile electronic device or a laptop device or an external display device attached via a display interface (e.g., DisplayPort, etc.). In one embodiment the display device 611 can be a head mounted display (HMD) such as a stereoscopic display device for use in virtual reality (VR) applications or augmented reality (AR) applications.

In some embodiments the platform controller hub 630 enables peripherals to connect to memory device 620 and processor 602 via a high-speed I/O bus. The I/O peripherals include, but are not limited to, an audio controller 646, a network controller 634, a firmware interface 628, a wireless transceiver 626, touch sensors 625, a data storage device 624 (e.g., hard disk drive, flash memory, etc.). The data storage device 624 can connect via a storage interface (e.g., SATA) or via a peripheral bus, such as a Peripheral Component Interconnect bus (e.g., PCI, PCI Express). The touch sensors 625 can include touch screen sensors, pressure sensors, or fingerprint sensors. The wireless transceiver 626 can be a Wi-Fi transceiver, a Bluetooth transceiver, or a mobile network transceiver such as a 3G, 4G, Long Term Evolution (LTE), or 5G transceiver. The firmware interface 628 enables communication with system firmware, and can be, for example, a unified extensible firmware interface (UEFI). The network controller 634 can enable a network connection to a wired network. In some embodiments, a high-performance network controller (not shown) couples with the interface bus 610. The audio controller 646, in one embodiment, is a multi-channel high definition audio controller. In one embodiment the system 600 includes an optional legacy I/O controller 640 for coupling legacy (e.g., Personal System 2 (PS/2)) devices to the system. The platform controller hub 630 can also connect to one or more Universal Serial Bus (USB) controllers 642 connect input devices, such as keyboard and mouse 643 combinations, a camera 644, or other USB input devices.

Illustrative examples of the technologies disclosed herein are provided below. An embodiment of the technologies may include any one or more, and any combination of, the examples described below.

Example 1 is a computer-implemented method, comprising establishing, in a trusted security manager of a trusted execution environment, a device update pre-authentication policy for a device communicatively coupled to the trusted execution manager; providing the device update pre-authentication policy to the device; receiving, from the device, a pre-authentication event signal; and providing, to the device, a pre-authentication event response comprising an update indicator to indicate to the device whether a runtime update may be performed.

Example 2 may include the subject matter of Example 1, wherein the pre-authentication policy comprises a binary value.

Example 3 may include the subject matter of Examples 1-2, wherein the pre-authentication event signal comprises at least one a firmware secure version number or a debug mode firmware image.

Example 4 may include the subject matter of Examples 1-3, further comprising requesting, from the device, additional update information.

Example 5 may include the subject matter of Examples 1˜4 wherein additional update information comprises at least one of a device firmware measurement or a firmware certificate.

Example 6 may include the subject matter of Examples 1-5, further comprising authenticating at least part of the additional update information.

Example 7 may include the subject matter of Examples 1-6, further comprising providing at least a portion of the additional update information to one or more additional devices.

Example 8 is an apparatus comprising a hardware processor to establish, in a trusted security manager of a trusted execution environment; a device update pre-authentication policy for a device communicatively coupled to the trusted execution manager; provide the device update pre-authentication policy to the device; receive, from the device, a pre-authentication event signal; and provide, to the device, a pre-authentication event response comprising an update indicator to indicate to the device whether a runtime update may be performed.

Example 9 may include the subject matter of Example 8, wherein the pre-authentication policy comprises a binary value.

Example 10 may include the subject matter of Examples 8-9, wherein the pre-authentication event signal comprises at least one a firmware secure version number or a debug mode firmware image.

Example 11 may include the subject matter of Examples 8-10, the hardware processor to request, from the device, additional update information.

Example 12 may include the subject matter of Examples 8-11, wherein additional update information comprises at least one of a device firmware measurement or a firmware certificate.

Example 13 may include the subject matter of Examples 8-12, the hardware processor to authenticate at least part of the additional update information.

Example 14 may include the subject matter of Examples 8-13, the hardware processor to provide at least a portion of the additional update information to one or more additional devices.

Example 15 is a computer-readable storage media comprising instructions stored thereon that, in response to being executed, cause a computing device to establish, in a trusted security manager of a trusted execution environment; a device update pre-authentication policy for a device communicatively coupled to the trusted execution manager; provide the device update pre-authentication policy to the device; receive, from the device, a pre-authentication event signal; and provide, to the device, a pre-authentication event response comprising an update indicator to indicate to the device whether a runtime update may be performed.

Example 16 may include the subject matter of Example 15, wherein the pre-authentication policy comprises a binary value.

Example 17 may include the subject matter of Examples 15-16, wherein the pre-authentication event signal comprises at least one a firmware secure version number or a debug mode firmware image.

Example 18 may include the subject matter of Examples 15-17, further comprising instructions to request, from the device, additional update information.

Example 19 may include the subject matter of Examples 15-18, wherein additional update information comprises at least one of a device firmware measurement or a firmware certificate.

Example 20 may include the subject matter of Examples 15-19, further comprising instructions to authenticate at least part of the additional update information.

Example 21 may include the subject matter of Examples 15-20, further comprising instructions to provide at least a portion of the additional update information to one or more additional devices.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
establishing, in a trusted execution environment of a computing device, an update for a pre-authentication policy for associated with a device in communication with the trusted execution environment of the computing device; and
providing, to the device, an update indicator to indicate to the device whether a runtime update based on the update is to be performed to the pre-authentication policy.

2. The method of claim 1, further comprising:
providing the update to the device;
receiving, from the device, a pre-authentication event signal indicating the device is ready to perform the update to the pre-authentication policy,
wherein the pre-authentication policy is based on a binary value.

3. The method of claim 1, wherein receiving the pre-authentication event signal comprises receiving one or more a firmware secure version number, a debug mode firmware image, a device firmware measurement, or a firmware certificate.

4.-21. (canceled)

22. The method of claim 1, wherein the computing device comprises one or more processors having application processors or graphics processors, wherein the computing device and the device are in communication over one or more communication networks including the Internet.

23. A computing device comprising:
processor circuitry to:
establish, in a trusted execution environment of the computing device, an update for a pre-authentication policy associated with a device in communication with the trusted execution environment of the computing device; and
provide, to the device, an update indicator to indicate to the device whether a runtime update based on the update is to be performed to the pre-authentication policy.

24. The computing device of claim 23, wherein the processor circuitry is further to:
provide the update to the device;
receive, from the device, a pre-authentication event signal indicating the device is ready to perform the update to the pre-authentication policy,
wherein the pre-authentication policy is based on a binary value.

25. The computing device of claim 23, wherein to receive the pre-authentication event signal comprises to receive one or more of a firmware secure version number, a debug mode firmware image, a device firmware measurement, or a firmware certificate.

26. The computing device of claim 23, wherein the processor circuitry comprises one or more of application processor circuitry of graphics processor circuitry, wherein the computing device and the device are in communication over one or more communication networks including the Internet.

27. At least one computer-readable medium having stored thereon instructions which, when executed, cause a computing device to perform operations comprising:
establishing, in a trusted execution environment of the computing device, an update for a pre-authentication policy associated with a device in communication with the trusted execution environment of the computing device; and
providing, to the device, an update indicator to indicate to the device whether a runtime update based on the update is to be performed to the pre-authentication policy.

28. The computer-readable medium of claim 27, wherein the operations further comprise:
providing the update to the device;
receiving, from the device, a pre-authentication event signal indicating the device is ready to perform the update to the pre-authentication policy,
wherein the pre-authentication policy is based on a binary value.

29. The computer-readable medium of claim 27, wherein receiving the pre-authentication event signal comprises receiving one or more of a firmware secure version number, a debug mode firmware image, a device firmware measurement, or a firmware certificate.

30. The computer-readable medium of claim 27, wherein the computing device comprises one or more processors including application processors or graphics processors, wherein the computing device and the device are in communication over one or more communication networks including the Internet.
